(19) United States
(12) Patent Application Publication
(10) Pub. No.: US 2019/0258510 A1
(43) Pub. Date: Aug. 22, 2019

(54) PROCESSOR STARVATION DETECTION

(71) Applicant: CA, inc., Islandia, NY (US)

(72) Inventors: Nathan A. Hastings, Victoria (AU); Justin J. McDonald, Tasmania (AU)

(21) Appl. No.: 15/899,608

(22) Filed: Feb. 20, 2018

(51) Int. Cl. G06F 9/48; G06F 9/30; G06F 9/50

(52) U.S. Cl. CPC G06F 9/4881; G06F 9/5005; G06F 9/3004

(57) ABSTRACT

A scheduler thread executes to queue a set of tasks for execution by a processor during a time interval. A counter associated with the particular time interval is incremented based on a determination that a time segment of the time interval has elapsed since a previous execution of the scheduler thread. Following the particular time interval, the counter is compared with a threshold value to determine whether the counter is less than the threshold value. It is determined that the processor has experienced a starvation state based at least in part on determining that the counter is less than the threshold value.

### BACKGROUND

The present disclosure relates in general to the field of computer systems, and more specifically, to processor starvation detection for server-based applications.

Some server-based applications, such as directory services (e.g., LDAP- or X.500-based directory services), may be sensitive to processor starvation events that occur at the server. For example, issues caused by processor starvation may be quite noticeable in directory services since they may run at the bottom of a software stack on a server. However, detection of such starvation events may be difficult without access to the server (e.g., in virtualization environments), and multiple resources may be needed to determine whether the cause of performance issues is related to the application itself or underlying hardware issues (e.g., processor starvation).

### BRIEF SUMMARY

According to one aspect of the present disclosure, a scheduler thread may execute to queue a set of tasks for execution by a processor during a time interval. A counter associated with the particular time interval may be incremented based on a determination that a time segment of the time interval has elapsed since a previous execution of the scheduler thread. Following the particular time interval, the counter may be compared with a threshold value to determine whether the counter is less than the threshold value. It may be determined that the processor has experienced a starvation state based at least in part on determining that the counter is less than the threshold value.

### BRIEF DESCRIPTION OF THE DRAWINGS

FIG. 1 illustrates an example server-based application environment.

FIG. 2 illustrates a simplified block diagram of an example directory service application running on a server device.

FIG. 3 illustrates an example processor starvation detection scenario within a time interval.

FIG. 4 illustrates an example processor starvation detection scenario at the boundary of a time interval.

FIG. 5A is a flowchart illustrating an example process for detecting starvation states in a processor using a counter.

FIG. 5B is a flowchart illustrating an example process for incrementing a counter to detect starvation states in a processor.

FIG. 6A is a flowchart illustrating another example process for detecting starvation states in a processor based on scheduled periodic tasks.

FIG. 6B is a flowchart illustrating an example process for determining whether a scheduled periodic task is overdue for execution.

Like reference numbers and designations in the various drawings indicate like elements.

### DETAILED DESCRIPTION

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

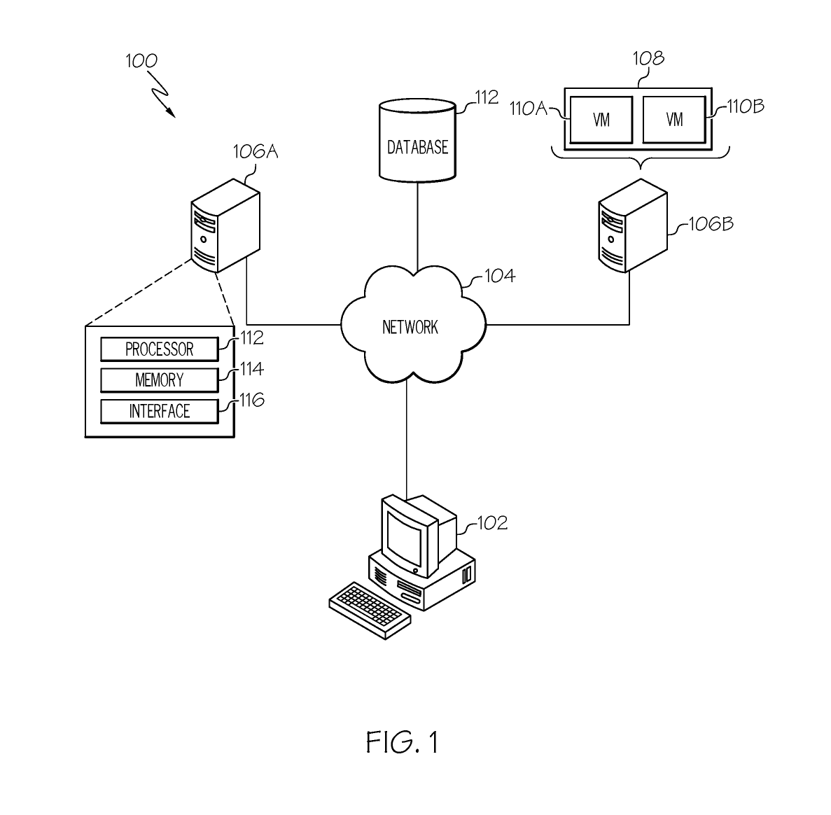

FIG. 1 illustrates an example server-based application environment 100. The example environment 100 includes a client device 102 communicably coupled to server devices 106 and a database 112 through a network 104. In general, elements of environment 100, such as “systems,” “servers,” “services,” “hosts,” “devices,” “clients,” “networks,” “mainframes,” “computers,” and any components thereof (e.g., 105, 110, 115, 120, 125, 135, 140, etc.), may include electronic computing devices operable to receive, transmit, process, store, or manage data and information associated with computing environment 100. As used in this disclosure, the term “computer,” “processor,” “processor device,” or “processing device” is intended to encompass any suitable processing device. For example, elements shown as single devices within computing environment 100 may be implemented using a plurality of computing devices and processors, such as server pools comprising multiple server computers. Further, any, all, or some of the computing devices may be adapted to execute any operating system, including Linux, other UNIX variants, Microsoft Windows, Windows Server, Mac OS, Apple iOS, Google Android, etc., as well as virtual machines adapted to virtualize execution of a particular operating system, including customized and/or proprietary operating systems.

For instance, in the example shown, the server device 106A includes a processor 112, memory 114, and an interface 116. The example processor 112 executes instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. The processor 112 may be or include a general-purpose microprocessor, as a specialized co-processor or another type of data processing apparatus. In some cases, the processor 112 may be configured to execute or interpret software, scripts, programs, functions, executables, or other instructions stored in the memory 114. In some instances, the processor 112 includes multiple processors or data processing apparatuses.

The example memory 114 includes one or more computer-readable media. For example, the memory 114 may include a volatile memory device, a non-volatile memory device, or a combination thereof. The memory 114 can include one or more read-only memory devices, random-access memory devices, buffer memory devices, or a combination of these and other types of memory devices. The memory 114 may store instructions that are executable by the processor 112.

The example interface 116 provides communication between the server device 106A and one or more other devices connected to the network 104. For example, the interface 116 may include a network interface (e.g., a wireless interface or a wired interface) that allows communication between the server device 106A and the client device 102 or the database 112 through the network 104. The interface 116 may include another type of interface.

The network 104 may include one or more networks of different types, including, for example, local area networks, wide area networks, public networks, the Internet, cellular networks, Wi-Fi networks, short-range networks (e.g., Bluetooth or ZigBee), and/or any other wired or wireless communication medium.

In the example shown, the server device 106B provides a virtualization environment 108 in which virtual machines 110 run. The virtual machines 110 may be adapted to virtualize execution of an operating system or other software such that each virtual machine 110 performs like a distinct computing device (e.g., the server device 106A) connected to the network 104. The server device 106B may be configured in the same manner as the server device 106A, and may include a processor, memory, and interface as described above.

In the example shown, the server devices 106 run an application that controls access to the database 112 by the client device 102. The application may include a directory service. A directory service may refer to an information management scheme that provides references between various data elements in a database. The directory service may allow for the storage and access of information about people, resources, systems, or other objects of an organization. Directory services may utilize a schema that provides for how data is stored for each data element (e.g., each object). For instance, the directory service schema may define the kinds of objects that can be stored in the directory and the types of information the objects may contain. In some instances, the directory service may provide a hierarchical directory structure. In other instances, the directory service may provide a flat directory structure. In some cases, the data in a directory service can be divided, distributed, or replicated (e.g., between or among various server devices). The directory service may be configured according to a standard, such as the X.500 or LDAP standard.

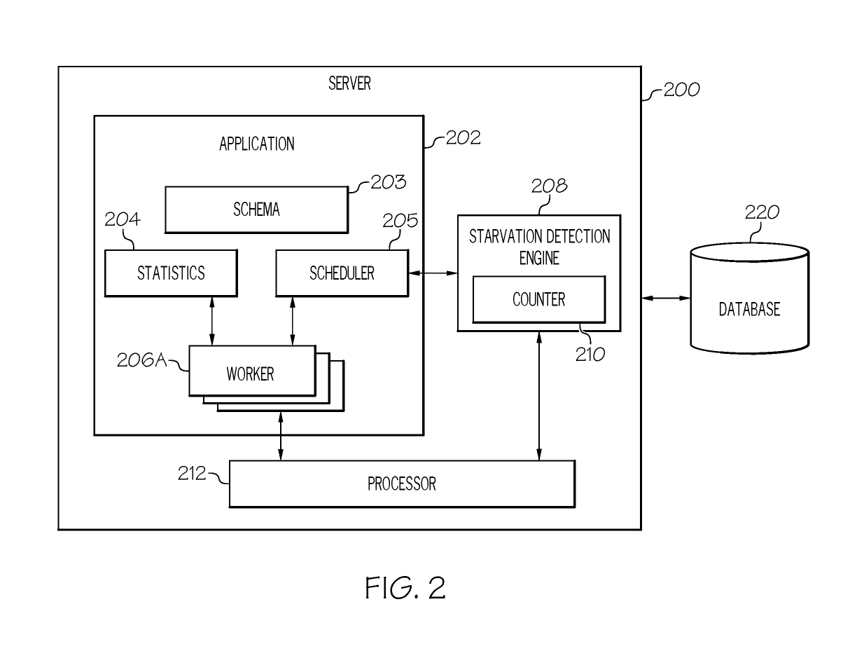

Referring to the example environment 100 of FIG. 1, the server devices 106 may run a directory service application that provides relationships between data elements in the database 112. The directory service may be distributed, replicated, or both between the server devices 106A, 106B (i.e., the virtual machines 110 running thereon). At times, the client device 102 may initiate a query for information in the database 112. The query may be sent to one or both of the server devices 106 for execution, and the directory service application running on the server devices 106 may return data to the client device 102 in response. In some cases, the directory service application running on the server devices 106 may be configured to run in a similar manner as described below with respect to the application 202 running on server device 200 of FIG. 2.

While the environment 100 of FIG. 1 is described as containing or being associated with the plurality of elements shown, not all elements illustrated within environment 100 of FIG. 1 may be utilized in each alternative implementation of the present disclosure. Additionally, one or more of the elements described in connection with the examples of FIG. 1 may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

FIG. 2 illustrates a simplified block diagram of an example directory service application 202 running on a server device 200. In the example shown, the application 202 provides a directory service to client devices for data stored in the database 220. Although shown in FIG. 2 and described herein as running on a single service device 200, the application 202 may run on multiple server devices (e.g., in a distributed or replicated directory service environment). Furthermore, although described herein with respect to aspects of a directory service, the techniques described herein for detecting processor starvation may be applied to other types of server-based applications.

In the example shown, the application 202 includes a schema 203 that defines the types of objects and relationships that can be stored in the directory provided by the application 202, a statistics logging thread 204, a scheduler thread 205 that schedules or queues tasks for execution by the processor 212 of the server device 200, worker threads 206 that facilitate execution of scheduled tasks or other tasks by the processor 212. In some instances, the application 202 runs at the bottom of a software stack on the server device 200.

A starvation detection engine 208 on the server device 200 detects, using a counter 210, whether the processor 212 has experienced a starvation state. A starvation state may refer to the processor 212 being unavailable to execute scheduled tasks for more than a minimum number of time segments of a time interval (e.g., a minimum number of seconds of a minute), whether the time segments are contiguous or not.

The scheduler thread 205 may run independently of the worker threads 206 that are handling tasks for execution by the processor 212 (e.g., directory queries). In some instances, the scheduler thread 205 may be configured to run at least once every time segment (e.g., every second) when the server device 200 is idle (e.g., no pending queries or other tasks), and more often when the server device 200 is under load (e.g., many pending queries to perform). The scheduler thread 205 may manage a number of time-based tasks, such as statistics logging using the statistics logging thread 204. For example, in some cases, the scheduler thread 205 may schedule the statistics logging thread 204 to run once per time interval (e.g., at the beginning of every minute). The scheduler thread 205 may also schedule other time-based tasks as well. The statistics logging thread 204 may log details about the activity of the server device 200, such as the number of operations executed by the processor 212, the number of queued requests, a counter value for the time interval as described below, or other information about the operations of the application 202.

In high performance X.500- or LDAP-based directory services, such as application 202, response times for queries may be measured in milliseconds. In some instances, intermittent performance issues may cause response times to increase. Many times, these issues may be due to problems in the environment (e.g., server device 200) hosting the application 202, rather than caused by the performance of the application itself. A particularly difficult type of issue to diagnose is processor starvation at the host system (e.g., starvation of the processor 212 of the server device 200). Processor starvation may refer to instances when the directory service processes are prevented from executing on the processor 212 for an extended period of time. If the directory service is starved of processor resources, a directory query may appear to take an abnormally large amount of time to complete on the client side, at no fault of the application 202. Processor starvation may be especially difficult to diagnose when the application runs on a virtual machine (e.g., the virtual machines 110 of FIG. 1). For instance, a number of virtual machine events, such as taking snapshots or migrating the virtual machine from one physical device to another, can cause the entire virtual machine instance to be temporarily paused with no process of the application executing for the entire duration of the event.

Thus, techniques of the present disclosure may use the scheduler thread 205 to determine whether starvation is occurring in the processor 212 of the host device. In general, this may be performed by the starvation detection engine 208, which may count (using the counter 210) the number of individual seconds the scheduler thread 205 executes at least once within a time interval. The time interval chosen may correspond with the interval at which the statistics logging thread 204 executes. For example, if the statistics logging thread 204 runs every minute, the number of seconds counted by the starvation detection engine 208 may be within the minute interval. In a healthy system, assuming an interval of 60 seconds for the statistics logging thread 204, the counter 210 should total 60 at the end of each interval. If the counter totals less than 60, however, it may indicate processor starvation events during the interval. For example, if the counter 210 totals 57 at the end of a minute interval, then it may be determined that there were 3 seconds during the interval during which the scheduler thread 205 did not execute.

Considering a processor 212 with a clock of 3 GHz, in each second there may be 3,000,000,000 instructions executed in each core of the processor 212. If the processor clock is 3 GHz and the processor 212 has 4 cores, approximately 12 billion instructions can be executed per second. To record an active processor second in the counter 210, the scheduler thread 205 may only need a tiny fraction of this instruction bandwidth.

In order to prevent false positives or unnecessary alerts, a threshold value may be used for comparison with the counter 210 for each time interval. For example, a threshold value of 55 may be used, indicating that processor starvation may be defined by the processor being unavailable for at least 5 seconds of a 60 second time interval (where 5 represents the maximum number of time segments tolerable for processor starvation). The threshold value may be a different value than 55, and may be configurable depending on the particulars of individual environments. If the counter 210 does not meet or exceed the threshold value, an alert may be generated or otherwise logged.

In some instances, the starvation detection engine 208 may use the following example pseudocode for detecting a starvation state in the processor 212 according to this technique:

```
while(1) {
executeScheduledEvents( );
queueRequests( );
if(currentTimeInSeconds( ) > lastTime) {
        lastTime = currentTimeInSeconds( );
        cpuSeconds++;
}
  if(cpuSeconds < threshold)
        cpuStarvationDetected( );
```

In this example, executeScheduledEvents( ) refers to a process for executing scheduled tasks on the processor 212 (e.g., using the worker threads 206), queueRequests( ) refers to a process of scheduling tasks for execution by the processor 212 (e.g., using the scheduler thread 205), currentTimeInSeconds( ) refers to an integer time value in seconds for a current time of execution, lastTime( ) refers to an integer time value in seconds for a previous execution, cpuSeconds refers to the counter value described above, and threshold refers to the threshold value described above. In some cases, however, the logic for determining processor starvation based on the threshold value may be:

if((60 − cpuSeconds) > threshold)
cpuStarvationDetected( );

where the threshold refers to the maximum number of time segments of processor starvation to be tolerated before generating an alert. For instance, referring to the example described above, the threshold value in this scenario may be 5 instead of 55 as before. By implementing this technique, an indicator of cumulative processor starvation during different time intervals may be determined rather than processor starvation for contiguous blocks of time. That is, processor starvation need not occur in contiguous time segments within a time interval for the starvation detection engine 208 to detect an overall starvation state of the processor 212.

While the above technique can detect processor starvation that occurs within the statistics logging interval, if there is a significant processor starvation event that crosses the interval, it may not be detected. For example, if the starvation event begun at the 58th second of a first 60 second interval and lasted for 62 seconds (into a third 60 second interval), the starvation might not be detected since counter values may be 57 and 58, respectively, at the end of each available interval (due to an entire minute not having a statistics logging process executed). Thus, the statistics logging thread 204 may be used in some cases to detect processor starvation, in addition to the counting technique described above. For example, if the statistics logging thread 204 determines that it is overdue for execution by at least a time interval, an alert may be generated or otherwise logged, even though counter values for respective time intervals are above the threshold value described above.

In some instances, determining whether the statistics logging is overdue may be accomplished by keeping a record of the time at which the last statistics log entry was recorded by the statistics logging thread 204, subtracting it from the current time of execution, then subtracting the expected time interval (e.g., 60 seconds) from this value. If the difference is not zero, it may be compared to another threshold value based on the threshold value described above. For example, if the maximum number of time segments of processor starvation to be tolerated is 5 seconds (indicating example threshold values for the counting technique of 55 or 5, depending on the implementation), then the difference may be compared with 5. If the difference is greater than the threshold value, an alert may be generated.

In some instances, the starvation detection engine 208 may use the following example pseudocode for detecting a starvation state in the processor 212 according to this technique:

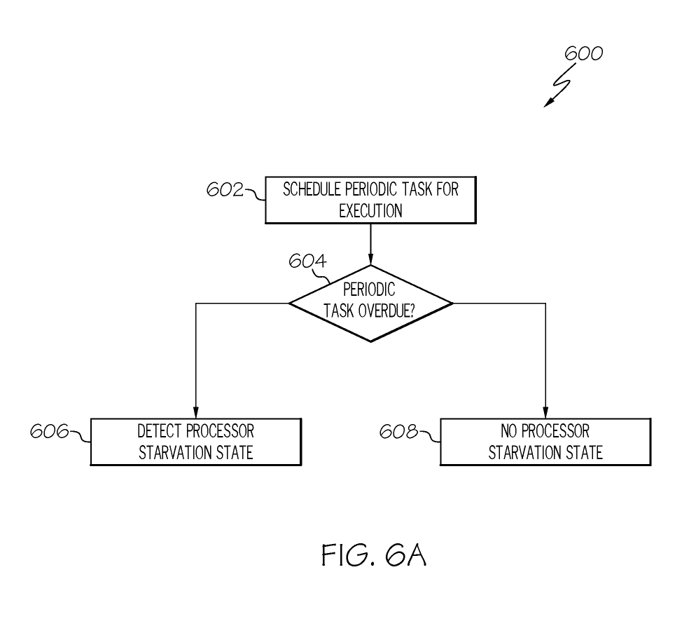

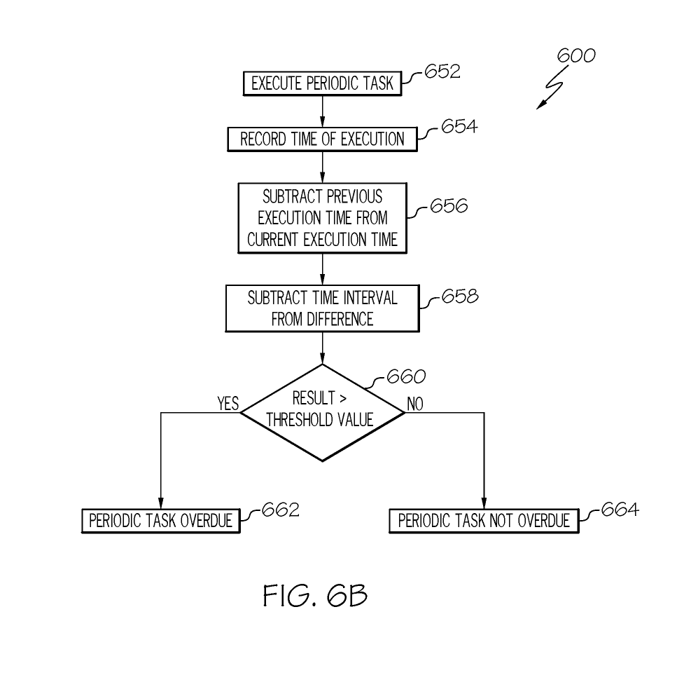

```
logStats( ) {
    If(isOverDue( ))
        cpuStarvationDetected( );
}
```

where logStats( ) refers to an execution of the statistics logging thread 204 and isOverDue( ) refers to a function for determining whether the statistics logging is overdue (e.g., based on the process described above, and below with respect to FIG. 6B). By implementing both techniques described above, aspects of the present disclosure may detect processor starvation states both within a time interval (using the counter value) and at the boundary of the time interval (by detecting whether the statistics logging is overdue).

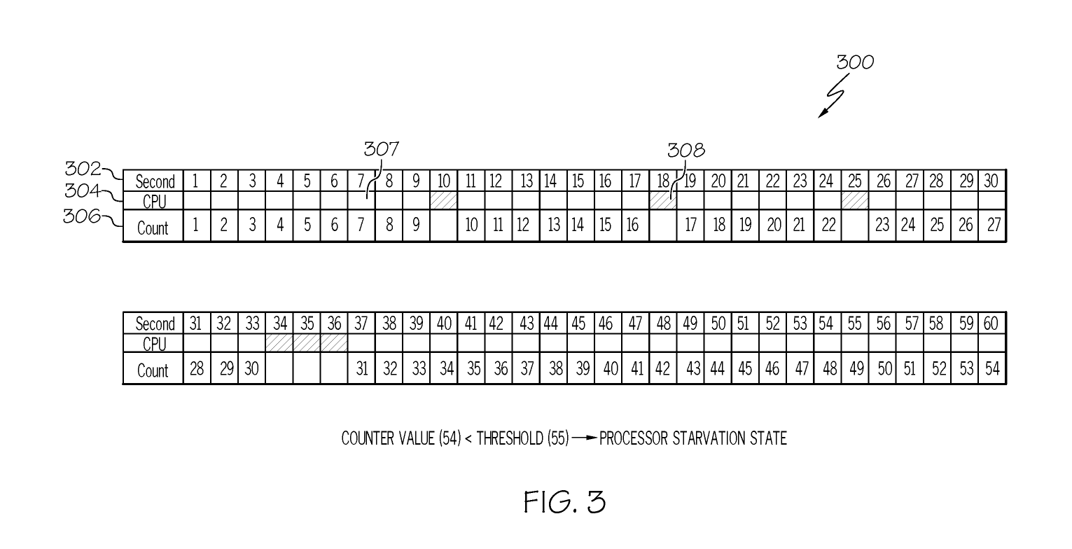

FIG. 3 illustrates an example processor starvation detection scenario 300 within a time interval. In the example shown, the field 302 represents a time segment (in seconds), the field 304 represents whether a central processing unit (CPU) of a server device (e.g., a server device 106 of FIG. 1, or the server device 200 of FIG. 2) is available to execute tasks during a particular time segment, and the field 306 represents the value of a counter (e.g., the counter 210 of FIG. 2) used for detecting starvation states in the CPU. A starvation state may refer to a scenario in which the CPU (or other processor) is unavailable to execute instructions for at least a certain number of time segments within a time interval.

As shown in FIG. 3, when the CPU is available to execute instructions during a particular time segment (e.g., during time segment 307), the counter value is incremented. Conversely, when the CPU is unavailable to execute instructions during a particular time segment (e.g., during time segment 308), the counter value is not incremented. In some cases, CPU availability may be determined using a scheduler thread of an application that is configured to execute at least once every time segment. For example, the counter value may be configured to increment after each execution of the scheduler thread if it has been at least a second since the last execution of the scheduler thread.

At the end of the time interval (e.g., 60 seconds as shown in FIG. 3), the counter value may be compared with a threshold value to determine whether the CPU experienced a starvation state during the time segment. The threshold value may be associated with a minimum number of time segments indicated as being within proper CPU availability limits (or a maximum number of time segments of processor unavailability that is tolerable). For example, a threshold value of 55 may be used where the minimum number of available time segments is 55 (thus, the maximum number of time segments of unavailability that is tolerable is 5 for an interval of 60 time segments). Another suitable threshold value may be used (e.g., 45, 50, 56, 57, or another value).

In the example shown in scenario 300, the counter value is 54 after the time interval of 60 seconds. Using an example threshold value of 55, a CPU starvation state may be detected based on a comparison of the counter value of 54 with the threshold value of 55. If, however, the threshold value was 50 instead of 55, a CPU starvation would not be detected. Other manners of comparing the counter value and the threshold value may be used. For instance, where the maximum tolerable number of unavailable time segments for an interval is 5, as before, the threshold value may be 5 and the comparison of the threshold value and counter value may be based on subtracting the counter value from the number of time segments of the time interval (e.g., 60−54=6) and comparing that value with the threshold value of 5. If the modified counter value (e.g., 6) is greater than the threshold value of 5, then a CPU starvation state may be detected; otherwise, no CPU starvation state may be detected.

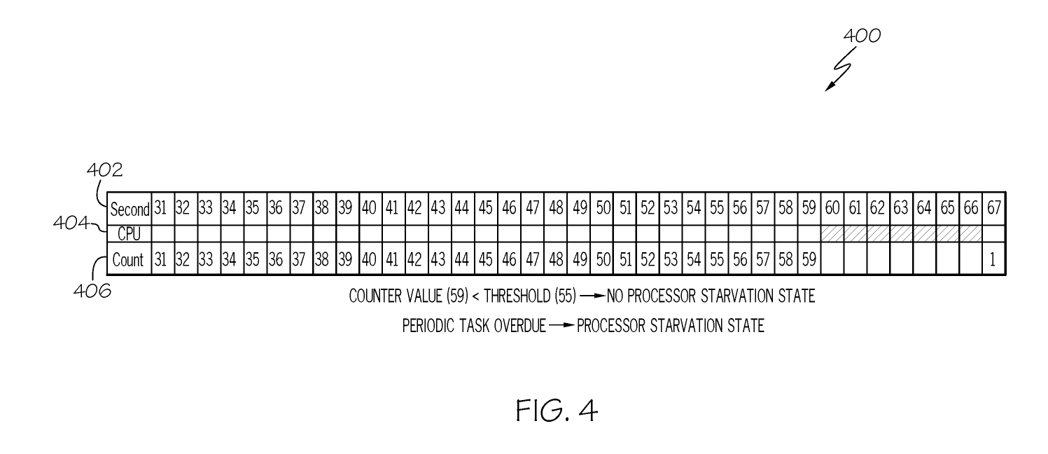

FIG. 4 illustrates an example processor starvation detection scenario 400 at the boundary of a time interval. In the example shown, the fields 402, 404, 406 represent the same information as fields 302, 304, 306 of FIG. 3. As shown in the example scenario of FIG. 4, the CPU of the server device is unavailable to execute instructions during seconds 60-66, but is otherwise available to execute instructions before and after this period of time. In this example scenario, the counter value for the time interval between 1-60 seconds is 59. Because this counter value is above the example threshold value of 55, CPU starvation will not be detected using the techniques described in FIG. 3.

Thus, to detect CPU starvation in this scenario, a periodic task that is scheduled for execution at the beginning of each time interval (e.g., at time segments 1, 61, 121, etc.) may be analyzed to determine whether it is overdue by a threshold number of time segments. For example, determining whether the periodic task is overdue may be accomplished by keeping a record of the time at which the periodic task was last executed, subtracting the previous time from the current time of execution, then subtracting the number of time segments in the time interval (e.g., 60 seconds here). If the difference is not zero, it may be compared to a threshold value that is based on the maximum number of unavailable time segments tolerable by the application. If the periodic task is overdue by a greater amount of time than the threshold number of time segments, then a CPU starvation state may be detected.

In some cases, the threshold value used in this analysis may be based on the threshold value used in the technique of FIG. 3. For instance, a threshold value of 5 may be used in the technique of FIG. 4 where a threshold value of 55 is used in the technique of FIG. 3. In the example shown, CPU starvation may be detected because the periodic task scheduled for execution at time segment 61 won't execute until at least time segment 67, and is therefore overdue by more than the example minimum number of time segments (5).

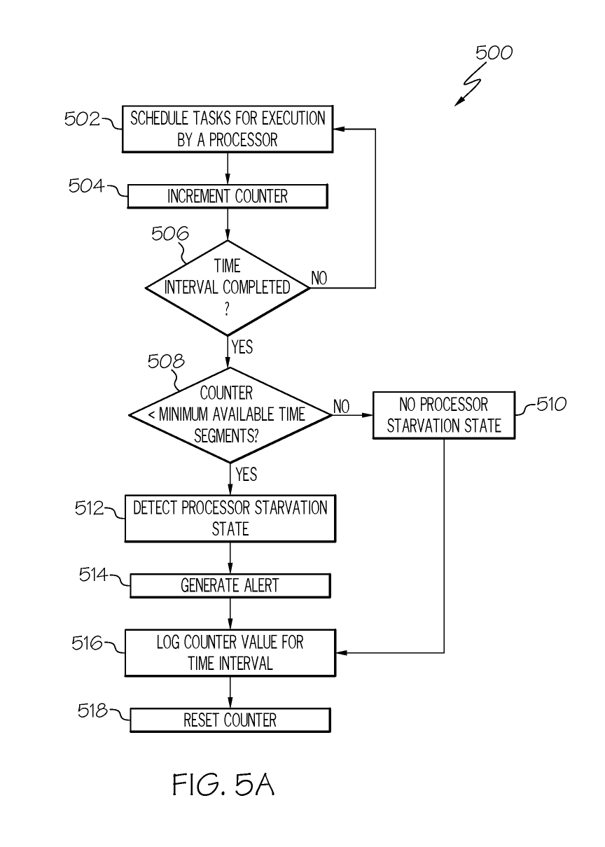

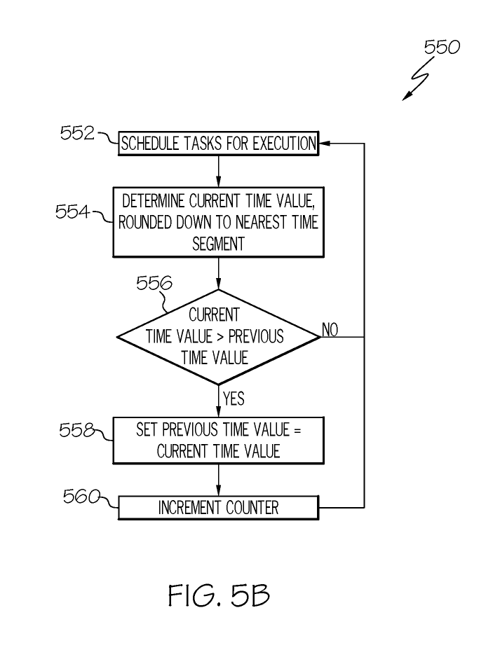

FIG. 5A is a flowchart illustrating an example process 500 for detecting starvation states in a processor using a counter. Operations in the example process 500 may be performed by components of a server device (e.g., the server devices 106 of FIG. 1) running one or more applications thereon. The example process 500 may include additional or different operations, and the operations may be performed in the order shown or in another order. In some cases, one or more of the operations shown in FIG. 5A are implemented as processes that include multiple operations, sub-processes, or other types of routines. In some cases, operations can be combined, performed in another order, performed in parallel, iterated, or otherwise repeated or performed another manner.

At 502, a set of tasks are scheduled for execution by a processor. The scheduling may be performed by a scheduling process, such as a scheduling thread, of an application. For example, the set of tasks may be scheduled by a scheduler thread of a directory service application implemented similar to the scheduler thread 205 of FIG. 2.

At 504, a counter is incremented. The counter may be incremented after execution of the tasks scheduled at 502. If there are no tasks to be scheduled at 502, then the counter may be incremented without executing any tasks. In some cases, the counter may be incremented as described below with respect to the process 550 FIG. 5B. For example, the counter may be incremented if at least a second has passed since the last set of tasks were executed at 502, but not incremented if less than a second has passed since the last set of tasks were executed at 502.

At 506, it is determined whether a time interval is completed. For instance, referring to the scenario 300 of FIG. 3, it may be determined whether the example time interval of 60 seconds is complete. If not, additional tasks are scheduled for execution by the processor at 502 and the counter is incremented again at 504 (e.g., after execution of the tasks scheduled at 502, if any).

If the time interval is completed, then it is determined at 508 whether the counter is less than a minimum number of available time segments indicated for processor starvation. For instance, referring again to the scenario 300 of FIG. 3, it may be determined whether the counter is less than 55, which may be a pre-determined threshold value for the detection of processor starvation. The threshold value may be any suitable value. The counter and threshold value may be compared in another suitable manner. If the counter is greater than the threshold value at 508, then no processor starvation state is detected at 510. If, however, the counter is less than the threshold value at 508, then a processor starvation state is detected at 512 and an alert is generated at 514. The counter value for the time interval is logged at 516 (regardless of whether a processor starvation state is detected), and the counter is reset. The process 500 may then repeat one or more additional times.

FIG. 5B is a flowchart illustrating an example process 550 for incrementing a counter to detect starvation states in a processor. Operations in the example process 550 may be performed by components of a server device (e.g., the server devices 106 of FIG. 1) running one or more applications thereon. The example process 550 may include additional or different operations, and the operations may be performed in the order shown or in another order. In some cases, one or more of the operations shown in FIG. 5B are implemented as processes that include multiple operations, sub-processes, or other types of routines. In some cases, operations can be combined, performed in another order, performed in parallel, iterated, or otherwise repeated or performed another manner. In some instances, operations in the process 550 of FIG. 5B may be performed as a sub-process of the operations in process 500 of FIG. 5A.

At 552, a set of tasks are scheduled for execution by a processor. The scheduling may be performed by a scheduling process, such as a scheduling thread, of an application. For example, the set of tasks may be scheduled by a scheduler thread of a directory service application implemented similar to the scheduler thread 205 of FIG. 2.

At 554, a current time value is determined. The current time value may be determined after execution of the tasks scheduled at 702. In some cases, the current time value may be determined by rounding a current time down to a nearest integer value of the time segment. For instance, referring to the example scenario 300 of FIG. 3, if the tasks are executed during the time between seconds 2 and 3, the current time value may be 2.

At 556, it is determined whether the current time value is greater than a previous time value time value associated with a previous execution of queued tasks. If the current time value is not greater than the previous time value at 556, then additional tasks scheduled for execution are executed at 552. If the current time value is greater than the previous time value at 556, then the previous time value is set equal to the current time value at 558 and the counter used to detect processor starvation states is incremented at 560.

FIG. 6A is a flowchart illustrating an example process 600 for detecting starvation states in a processor based on scheduled periodic tasks. Operations in the example process 600 may be performed by components of a server device (e.g., the server devices 106 of FIG. 1) running one or more applications thereon. The example process 600 may include additional or different operations, and the operations may be performed in the order shown or in another order. In some cases, one or more of the operations shown in FIG. 6A are implemented as processes that include multiple operations, sub-processes, or other types of routines. In some cases, operations can be combined, performed in another order, performed in parallel, iterated, or otherwise repeated or performed another manner. In some instances, operations in the process 600 of FIG. 6A may be performed in parallel with the operations in process 500 of FIG. 5A

At 602, a periodic task is scheduled for execution. The periodic task may include a particular task of an application that is configured to execute once every time interval. The periodic task may be scheduled by a scheduler thread of the application. For example, the periodic task may be scheduled by a scheduler thread of a directory service application implemented similar to the scheduler thread 205 of FIG. 2.

At 604, it is determined whether the periodic task is overdue for execution. Determining whether the periodic task is overdue may include determining whether the periodic task has not executed after a minimum number of time segments of the time interval. In some cases, the minimum number of time segments are based on the threshold value. For example, where the threshold value used in the process 500 of FIG. 5A is 55 (indicating that 55 is the minimum number of available time segments tolerable for processor starvation), then the threshold value used at 604 may be 5 (i.e., 60−55=5). In some instances, the process 650 of FIG. 6B may be used to determine whether the periodic task is overdue.

If the task is determined to be overdue at 604 by a threshold number of time segments, then a processor starvation state may be detected at 606. For instance, referring to the scenario 400 of FIG. 4, the periodic task may be scheduled for execution at time segment 61, but may not execute until at least time segment 67 since the CPU is unavailable until then. The periodic task in the example scenario of FIG. 4 may be considered overdue where an example threshold of 5 is used. If the task is not determined to be overdue at 604, then no processor starvation state is detected at 608.

FIG. 6B is a flowchart illustrating an example process 650 for determining whether a scheduled periodic task is overdue for execution. Operations in the example process 650 may be performed by components of a server device (e.g., the server devices 106 of FIG. 1) running one or more applications thereon. The example process 650 may include additional or different operations, and the operations may be performed in the order shown or in another order. In some cases, one or more of the operations shown in FIG. 6B are implemented as processes that include multiple operations, sub-processes, or other types of routines. In some cases, operations can be combined, performed in another order, performed in parallel, iterated, or otherwise repeated or performed another manner. In some instances, operations in the process 650 of FIG. 6B may be performed as a sub-process of the operations in process 600 of FIG. 6A.

At 652, a periodic task is executed. The periodic task may be scheduled for execution using a scheduler, as described above, and may be scheduled to execute once every time interval. For example, a scheduler may schedule the periodic task for execution once every minute, at the top of the minute. At 654, the time of execution of the periodic task is recorded. The time of execution of the periodic task is then compared with a previous time of execution for the periodic task by subtracting the previous execution time from the current execution time (recorded at 654) at 656, and then subtracting the time interval from the difference at 658.

At 660, the result from 658 is compared to a threshold value. The threshold value may be based on a maximum tolerable number of time segments during which the processor is unavailable. In some instances, the threshold value may be based on the threshold value used in the process 500 of FIG. 5A. For example, if a maximum tolerable number of time segments for processor starvation is 5 seconds, then the result from 658 may be compared with 5. If the result is greater than the threshold value, then it may be determined that the periodic task is overdue at 662. If the result is less than the threshold value, then it may be determined that the periodic task is not overdue at 664.

It should be appreciated that the flowcharts and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

1. A method, comprising:
executing a scheduler thread to queue a set of tasks for execution by a processor during a time interval;
incrementing a counter associated with the particular time interval based on a determination that a time segment of the time interval has elapsed since a previous execution of the scheduler thread;
comparing the counter with a threshold value following the particular time interval to determine that the counter is less than the threshold value; and
determining that the processor has experienced a starvation state based at least in part on determining that the counter is less than the threshold value.

2. The method of claim 1, further comprising:
executing the scheduler thread to queue a particular task for execution at the beginning of the time interval, wherein the particular task is a periodic task to be executed in a logging process; and
determining whether execution of the particular task is overdue;
wherein determining that the processor has experienced a starvation state is further based on a determination that the particular task is overdue.

3. The method of claim 2, wherein determining whether the particular task is overdue comprises determining whether the particular task has not executed after a minimum number of time segments of the time interval, and the minimum number of time segments are based on the threshold value.

4. The method of claim 3, wherein the threshold value is a first threshold value, and determining whether the particular task has not executed after a minimum number of time segments of the time interval comprises:
recording a current time of execution of the particular task;
subtracting the current time of execution from a previous time of execution of the particular task;
subtracting the time interval from the difference; and
comparing the result of the subtraction to a second threshold value to determine that the particular task is overdue.

5. The method of claim 4, wherein the second threshold value is based on the first threshold value.

6. The method of claim 1, wherein incrementing the counter associated with the particular time interval comprises:
determining a previous time value associated with a previous execution of the scheduler thread;
determining a current time value associated with a current execution of the scheduler thread;
comparing the current time value with the previous time value to determine that the current time value is greater than the previous time value;
incrementing the counter based on determining that the current time value is greater than the previous time value by at least a time segment; and
setting the previous time value equal to the current time value.

7. The method of claim 6, wherein determining the current time value comprises rounding down to a nearest integer time segment value of the time interval.

8. The method of claim 1, wherein the scheduler thread is associated with an application and is to schedule worker threads to handle tasks of the application at least every time segment of the time interval.

9. The method of claim 1, wherein the set of tasks comprise tasks of a directory service application.

10. The method of claim 9, wherein the processor comprises a processor of a server system hosting the directory service application.

11. The method of claim 10, wherein the directory service application is hosted on a virtual machine running on the server system.

12. The method of claim 9, wherein the directory service application comprises the scheduler thread, and the threshold value is based on a minimum amount of processor resources for use by the scheduler thread.

13. The method of claim 9, wherein the scheduler thread is to manage a set of time-based events and the set of tasks correspond to the set of time-based events.

14. The method of claim 9, wherein the directory service application runs at the bottom of a software stack of a server system hosting the directory service application.

15. The method of claim 1, wherein the counter is incremented based on non-contiguous starvation events within the time interval.

16. A non-transitory computer readable medium having program instructions stored therein, wherein the program instructions are executable by a computer system to perform operations comprising:
executing a scheduler thread to queue a set of tasks for execution by a processor;
determining whether to increment a counter associated with a number of executions of the scheduler thread within a time interval, wherein the counter is to be incremented to correspond with a respective execution of the scheduler thread after a time segment of the time interval;
determining that a number of executions of the scheduler thread counted during the time interval is less than a minimum number of executions in the time interval to detect that the processor was unavailable for a particular number of time segments within the time interval; and
generating an alert that the processor has experienced a starvation state based on detecting that the processor was unavailable for the particular number of time segments within the time interval.

17. The non-transitory computer readable medium of claim 16, wherein the operations further comprise:
determining that the particular number of time segments exceeds a threshold number, wherein the alert is generated to indicate whether the particular number of time segments exceeds the threshold number.

18. The non-transitory computer readable medium of claim 16, wherein the operations further comprise:
executing a logging thread at the beginning of the time interval;
determining whether the logging thread is overdue based on a previous time of execution of the logging thread; and
generating the alert that the processor has experienced a starvation state based on determining that the logging thread is overdue.

19. A system comprising:
a data processing apparatus;
memory; and
a starvation detection engine, executable by the data processing apparatus to:
identify tasks queued for execution by a processor during a time interval, wherein the tasks comprise a particular set of tasks queued by a scheduler thread;
increment a counter associated with the particular time interval based on a determination that a time segment of the time interval has elapsed since a previous execution of the scheduler thread;
compare the counter with a threshold value to determine that the counter is less than the threshold value following the end of the particular time interval; and
determine that the processor has experienced a starvation state based on determining that the counter is less than the threshold value.

20. The system of claim 19, further comprising a directory service application, the directory service comprising the scheduler thread and a logging thread, and wherein the starvation detection engine is further executable by the data processing apparatus to:
identify execution of a particular task scheduled for periodic execution according to a period corresponding to the time interval, wherein the particular task comprises a task of the logging thread;
determine whether the particular task is overdue based on a previous time of execution of the particular task; and
further detect whether the processor has experienced a starvation state based on a determination that the particular task is overdue.
